(19) United States
(12) Patent Application Publication
(10) Pub. No.: US 2004/0253143 A1
(43) Pub. Date: Dec. 16, 2004

(54) Method for processing waste liquid in cartridges and a chemical reaction cartridge applying the method

(75) Inventor: Kazuhisa Fukushima, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/865,757

(22) Filed: Jun. 14, 2004

(30) Foreign Application Priority Data
Jun. 16, 2003 (JP) 2003-170452
Aug. 28, 2003 (JP) 2003-303852

(51) Int. Cl. G01N 1/00

(52) U.S. Cl. 422/58

(57) ABSTRACT

The present invention allows the injection of liquid absorbent into a waste liquid tank, which is provided in a sealed diagnostic cartridge, and the absorption and gelation of hazardous substances such as waste liquid containing disease-causing bacteria and the like or endocrine-disrupting chemicals in said diagnostic cartridge by means of said liquid absorbent in said waste liquid tank, thereby facilitating the prevention of said hazardous substances in said waste liquid tank from being dispersed externally.

In addition, openings with access to external penetration are provided to said waste liquid tank while said openings are blocked by filters which only allow the permeation of gas through said openings, so that internal fluid transfer can be easily controlled.

### BACKGROUND OF THE INVENTION

1. Field of the Invention

The present invention relates to various chemical reaction cartridges such as biological diagnostic cartridges for use in genetic diagnostic systems or biological sensor cartridges for environmental measurements, more specifically, cartridges of a sealed structure wherein hazardous substances such as viruses or endocrine-disrupting chemicals are confined, to a method and structure of waste liquid processing for preventing hazardous substances in cartridges from external dispersion even if these cartridges are damaged, and to a structure for facilitating the transfer control of the fluid in these cartridges.

2. Description of the Prior Art

Recently, biological diagnostic cartridges for use in genetic diagnostic systems, biological sensor cartridges for environmental measurements, cartridges for analyses as described in International Publication WO 01/013127, and the like have been developed.

In these types of cartridges—for example, biological diagnostic cartridges or biological sensor cartridges for environmental measurements—it is necessary to prevent the hazardous substances contained in the samples, such as viruses or endocrine-disrupting chemicals, from being dispersed externally.

While some cartridges are structured to confine waste liquid within the cartridges, such as the buffer liquid used for analyses, even such cartridges have the problem that hazardous substances are dispersed if these cartridges are damaged.

As in the case of cartridges, the same necessity of preventing waste liquid from being dispersed externally applies to a lab-on-a-chip or a fab-on-a-chip using the so-called μTAS (micro total analysis systems), wherein experimental chambers, laboratories, chemical factories or the like are created on a chip.

### SUMMARY OF THE INVENTION

An object of the present invention is to solve the above-mentioned problem by providing a method for processing the waste liquid in cartridges, such as cartridges for genetic diagnoses, biological cartridges containing chips for environmental measurements, or a lab-on-a-chip or a fab-on-a-chip using μTAS (hereinafter collectively called “chemical reaction cartridges”), which enables the processing to prevent hazardous substances such as waste liquid containing disease-causing bacteria and the like or endocrine-disrupting chemicals from being dispersed externally.

Another object of the present invention is to realize chemical reaction cartridges, which use the above-mentioned method to gelate hazardous substances and are able to prevent hazardous substances from being dispersed externally even if the cartridges are damaged.

Yet another object of the present invention is to realize chemical reaction cartridges wherein openings are provided to facilitate the transfer control of internal fluid by blocking the openings with filters which only allow the permeation of gas.

### BRIEF DESCRIPTION OF THE DRAWINGS

FIG. 1 illustrates an embodiment of a chemical reaction cartridge concerning the present invention.

FIG. 2 is a cross-sectional view of the cartridge shown in FIG. 1.

FIG. 3 illustrates another embodiment of a chemical reaction cartridge concerning the present invention.

FIG. 4 is a cross-sectional view of the cartridge shown in FIG. 3.

### DETAILED DESCRIPTION OF THE PREFERRED EMBODIMENTS

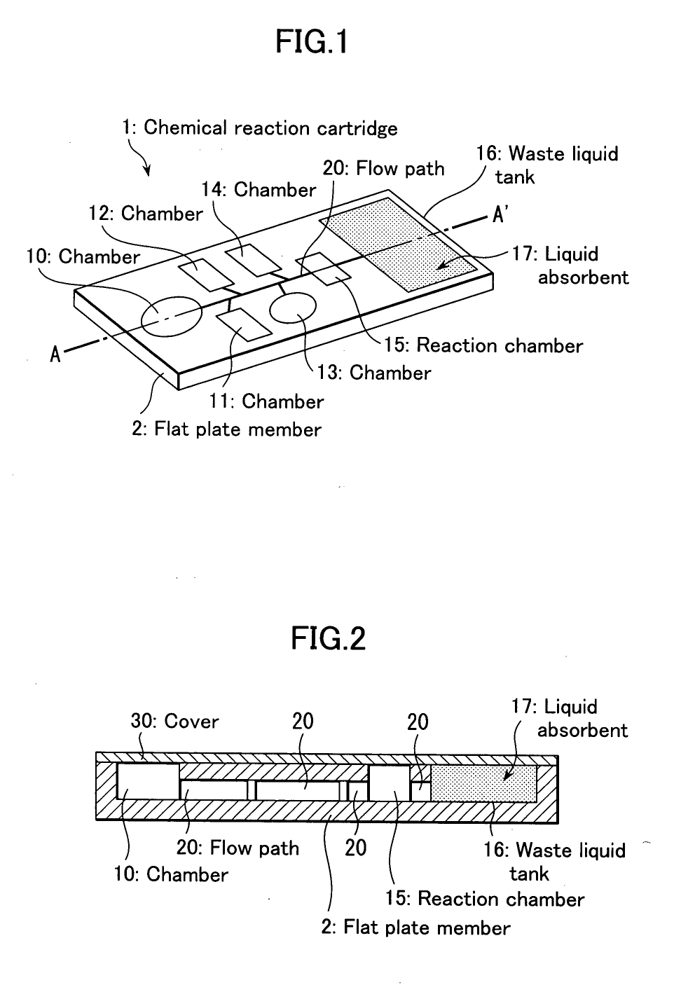

The present invention is herein explained in detail with reference to the drawings. FIG. 1 illustrates an embodiment of a chemical reaction cartridge concerning the present invention. FIG. 1 is a schematic perspective view of flat plate member 2 which comprises chemical reaction cartridge 1. A plurality of chambers 10 to 16 and flow path 20 for connection of the chambers are formed in flat plate member 2. Neither the holes of chambers 10 to 16 nor the groove of flow path 20 penetrate flat plate member 2.

Samples or measurement specimens (hereinafter called “samples”) are injected into chamber 10. A reagent or processing liquid to be mixed with the samples, a cleaning liquid or the like is properly stored in the other chambers 11 to 14. Chamber 15 is a reaction chamber into which samples from chamber 10, processing liquid from chambers 11 to 14 or the like are fed via flow path 20. Chamber 16 (hereinafter called “a waste liquid tank”) stores liquid absorbent 17, which absorbs and gelates the waste liquid.

A cover is placed in a sealed manner on the upper surface of the chemical reaction cartridge wherein these chambers and the flow path are formed. FIG. 2 is a cross-sectional view of a chemical reaction cartridge from A to A′, wherein cover 30 is placed on the cartridge shown in FIG. 1.

An operation method for such chemical reaction cartridges is now explained. Necessary reagent or processing liquid is injected into chambers 11 to 14 in advance. After a sample is injected into chamber 10, the sample is transferred to reaction chamber 15.

As an example of the methods for injecting samples into chamber 10, an inlet formed by means of an elastic body can be provided to the chemical reaction cartridge, while a syringe needle is inserted into the inlet to inject the samples.

In addition, transfer techniques such as the pressurization method or the pneumatic pressurization method can be used to transfer the samples. For example, in the case of the pneumatic pressurization method, a porous film which is permeable to gases such as air, but not liquids, is used as cover 30 to allow air to enter chamber 10 from the portion immediately above chamber 10 through the porous film so that the samples will be sent out. The same method applies to other chambers to send out their contents. Note that, in this case, it is necessary to prevent air from entering into or exiting from the chambers to which pneumatic pressurization is not applied, so that air will not exit to the outside through the porous film.

Samples, reagent, processing liquid or the like are properly fed into reaction chamber 15 in this manner. Measurement of a reacting substance after reaction in reaction chamber 15 is conducted by means of an external measuring instrument through an electrode (not illustrated) embedded in the reaction chamber, or by means of a reader (not illustrated) through a transparent window (not illustrated) provided in the upper surface of reaction chamber 15 if the emission of light from the reacting substance is to be measured.

While a series of these analysis preparations and measurements are conducted in the cartridge according to each stage of the protocols, the waste liquid generated on these respective occasions is finally collected in waste liquid tank 16. Liquid absorbent 17 stored in waste liquid tank 16 absorbs and gelates the waste liquid, thereby making it possible to safely capture hazardous substances such as waste liquid containing disease-causing bacteria or endocrine-disrupting chemicals in waste liquid tank 16 of the cartridge. Even if the cartridge is damaged, hazardous substances will not be dispersed because they have already been gelated. The gelation of the waste liquid by means of liquid absorbent 17 also prevents flowback towards reaction chamber 15.

Waste liquid tank 16 as mentioned above is very useful in making the cartridges smaller, because it does not require a valve to prevent flowback and also has a simple structure.

As explained above, the present invention has the following effects:

(1) If hazardous substances are handled in cartridges for genetic diagnoses, biological cartridges containing chips for environmental measurements, a lab-on-a-chip or a fab-on-a-chip using μTAS or the like, it is possible to easily prevent these hazardous substances from being dispersed if such means are damaged.

(2) It is possible to easily prevent the flowback of waste liquid in waste liquid tanks.

(3) It is an effective waste liquid processing method in terms of the miniaturization of cartridges.

It is to be understood that the present invention is not restricted to the foregoing embodiments. Rather, many other alterations and modifications thereof may be made without departing from the spirit and essential characteristics therein.

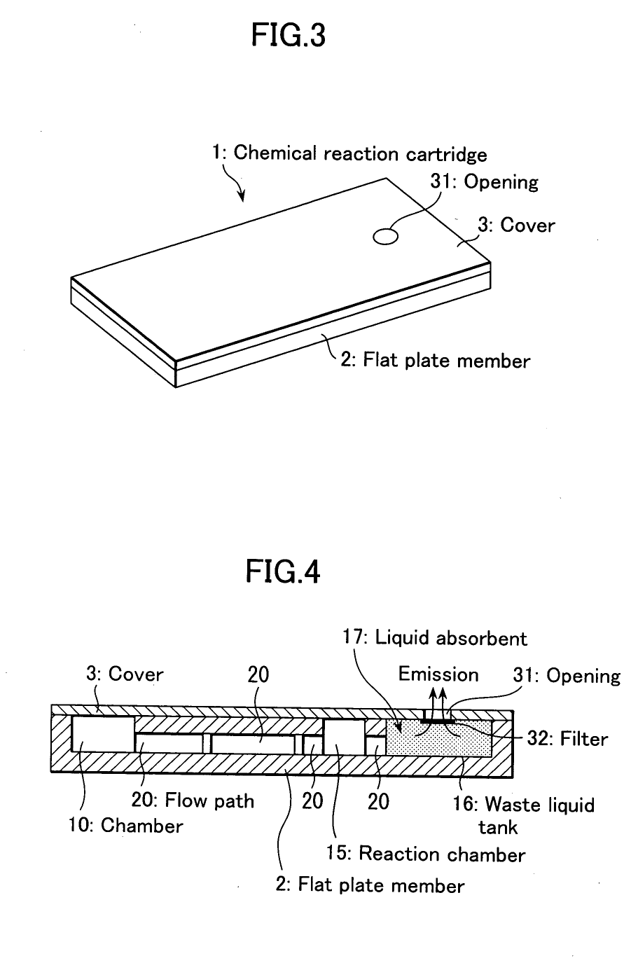

For example, it is also possible to provide an opening on top of waste liquid tank 16 at the final stage as shown in FIG. 3 to facilitate internal fluid control, and at the same time, to prevent internal fluid from spreading outside waste liquid tank 16. What is different between the cartridge shown in FIG. 3 and the cartridge shown in FIG. 1 and FIG. 2 is opening 31 for external penetration, which is provided in cover 3 on waste liquid tank 16.

The aperture of this opening which comprises a trough-hole is not limited to one and can be more than one. The aperture may not necessarily be located in one particular place and can be located in more than one place. As shown in FIG. 4, opening 31 is provided with filter 32, made of hydrophobic porous film, which is characterized to allow the permeation of gas but to occlude liquid and solid matter. Filter 32 is mounted on the surface, back (as in the figure), or in-between cover 3 so that waste liquid will not leak from opening 31.

If waste liquid tank 16 at the final stage has a sealed structure, it is necessary to evacuate air from the tank or to provide the tank with an aperture for external penetration in order to facilitate the fluid control of chambers or flow paths. Such an opening is provided in this embodiment. The prevention of waste liquid leakage at the opening is achieved by the combination of the prevention of waste liquid from spreading externally by means of filter 32 and the gelation of the hazardous waste liquid itself, which makes it difficult for the gel to spread externally.

In these cartridges, not only waste liquid but also gas already existing in the chambers or flow paths is fed into waste liquid tank 16. However, only the gas permeates through filter 32 and is emitted externally from opening 31. Thus, atmospheric pressure in waste liquid tank 16 or in other chambers will not increase when pressure is applied to the transfer fluid, thereby facilitating internal fluid control. In addition, even if the application of pressure for fluid transfer is stopped, the fluid in the chambers or flow paths will not flow back because there is no difference in atmospheric pressure within the cartridge.

The opening may not necessarily be a round hole but can be a hole of any shape. Alternatively, the opening may be composed of a plurality of holes or of a net-like structure, provided that all the holes of any opening are blocked by means of filters.

Although the opening is formed in cover 3 in the embodiment, the opening can be formed in flat plate member 2.

1. A method of processing waste liquid in a cartridge, comprising the steps of:
providing a sealed chemical reaction cartridge comprising a waste liquid tank:
adding a liquid absorbent to the waste liquid tank;
injecting liquid absorbent into the waste liquid tank;
adding waste liquid containing undesirable substances to the waste liquid tank;
absorbing the undesirable substances into the liquid absorbent from the waste liquid; and
gelating the undesirable substances and the waste liquid.

2. The method of claim 1 for processing waste liquid in a cartridge, wherein the chemical reaction cartridge is a cartridge for genetic diagnoses, a biological cartridge containing a chip for environmental measurements, or a lab-on-a-chip or fab-on-a-chip using micro total analysis systems.

3. A sealed chemical reaction cartridge comprising a waste liquid tank formed to receive and store waste liquid, wherein said waste liquid tank contains liquid absorbent for absorbing and gelating said received waste liquid.

4. The chemical cartridge of claim 3 wherein said waste liquid tank is provided with one or a plurality of openings with access to external penetration, wherein said openings are blocked by filters formed with hydrophobic porous films which allow the permeation of gas, but not liquid or solid matter.

5. The chemical reaction cartridge of claim 3, wherein said sealed chemical reaction cartridge is equipped with
a plurality of chambers for storing samples, reagents or processing liquid respectively,
a reaction chamber into which said samples, reagents or processing liquid is fed, and
a flow path to link said chambers with said waste liquid tank, and
a means to transfer said samples, reagents or processing liquid to said reaction chamber as well as to transfer said waste liquid to said waste liquid tank.

6. The chemical reaction cartridge of claim 3, wherein said chemical reaction cartridge is a cartridge for genetic diagnoses, a biological cartridge containing a chip for environmental measurements, or a lab-on-a-chip or fab-on-a-chip using micro total analysis systems.

7. The chemical reaction cartridge of claim 4, wherein said sealed chemical reaction cartridge is equipped with
a plurality of chambers for storing samples, reagents or processing liquid, respectively,
a reaction chamber into which said samples, reagents or processing liquid is fed, and
a flow path to link said chambers with said waste liquid tank, and
a means to transfer said samples, reagents or processing liquid to said reaction chamber as well as to transfer said waste liquid to said waste liquid tank.

8. The chemical reaction cartridge of claim 4, wherein said chemical reaction cartridge is a cartridge for genetic diagnoses, a biological cartridge containing a chip for environmental measurements, or a lab-on-a-chip or fab-on-a-chip using micro total analysis systems.
